(19) United States
(12) Patent Application Publication
(10) Pub. No.: US 2023/0061205 A1
(43) Pub. Date: Mar. 2, 2023

(54) LIGHT-AND-SHADOW DECORATION

(71) Applicant: Chin-Sheng Yang, Tainan City (TW)

(72) Inventor: Chin-Sheng Yang, Tainan City (TW)

(21) Appl. No.: 17/458,584

(22) Filed: Aug. 27, 2021

(51) Int. Cl. F21V 21/29; F21V 3/02; F21V 23/00; F21V 5/04; F21V 23/04

(52) U.S. Cl. CPC F21V 21/29; F21V 3/02; F21V 23/003; F21V 5/04; F21V 23/04

(57) ABSTRACT

A light-and-shadow decoration includes a main decorative object, an omnidirectional rotation mechanism, and an electrical control unit. The main decorative object includes a three-dimensional structure and has one side that is provided with a retaining seat. The omnidirectional rotation mechanism includes a support axle, a rotation base, and a projector. The support axle has two ends each provided with a universal-joint ball. The rotation base and the projector are respectively connected to the two ends of the support axle. The projector has one side on which a lighting cover is mounted. The electrical control unit includes a power supply portion and at least one light-emitting element. Light from the light-emitting element transmits through the lighting cover to project to the outside. As such, the omnidirectional rotation mechanism enables rotation of the light source relative to the main decorative object and the support axle for adjusting a projection direction thereof.

### TECHNICAL FIELD OF THE INVENTION

The present invention relates to decorations, and more particularly to a decoration structure that exhibits an effect of light and shadow.

### DESCRIPTION OF THE PRIOR ART

Modern people put a lot of emphasis on the quality of living and desire the design and arrangement of the living space to be one that shows atmosphere of easiness and egocentricity by means of for example an arrangement of or ornaments or lighting decorations in the living space to create an excellent atmosphere.

There are various types and fashions of lighting decorations that are available in the market, among which the most commonly seen include single-color lighting decorations, varying-color lighting decorations, or flashing lighting decorations. However, such known lighting decorations provide a fixed way of lighting. Although they can be arranged at different spaces, the direction in which lighting is projected is fixed and invariable and the direction of light projection is not adjustable, making a light shadow that is monotonous in respect of variation and less interesting.

### SUMMARY OF THE INVENTION

In view of the above, the primary objective of the present invention is to provide a light-and-shadow decoration, which comprises:

a main decorative object, which comprises a three-dimensional structure having a hollow interior, the main decorative object comprising a retaining seat provided on one side thereof;

an omnidirectional rotation mechanism, which comprises a support axle, a rotation base, and a projector, the support axle having two ends respectively formed with a first universal joint ball and a second universal joint ball, the rotation base having one side in which a first ball socket mating the first universal joint ball is formed, the projector having one side in which a second ball socket mating the second universal joint ball is formed and an opposite side on which a lighting cover is provided, the omnidirectional rotation mechanism being rotatably mounted to the retaining seat of the main decorative object by means of the rotation base so as to be rotatable relative to the main decorative object; and

an electrical control unit, which comprises a power supply portion disposed in the interior of the main decorative object and at least one light-emitting element disposed in an interior of the projector and in electrical connection with the power supply portion, light from the light-emitting element transmitting through the lighting cover to project to the outside.

As such, the rotation base is arranged as being rotatable relative to the main decorative object, and the projector is made rotatable by means of the first universal joint ball and the second universal joint ball, so that adjustment of a light projection direction relative to the main decorative object is made possible.

### BRIEF DESCRIPTION OF THE DRAWINGS

FIG. 1 is a perspective view of the present invention taken from a front side.

FIG. 2 is a perspective view of the present invention taken from a rear side.

FIG. 3 is an exploded view of the present invention.

FIG. 4 is an exploded view showing an omnidirectional rotation mechanism according to the present invention.

FIG. 5 is a cross-sectional view of the present invention.

FIG. 6 is an exploded view showing an illustrative example of the present invention.

FIG. 7 is a perspective view showing the illustrative example of the present invention.

### DETAILED DESCRIPTION OF THE PREFERRED EMBODIMENT

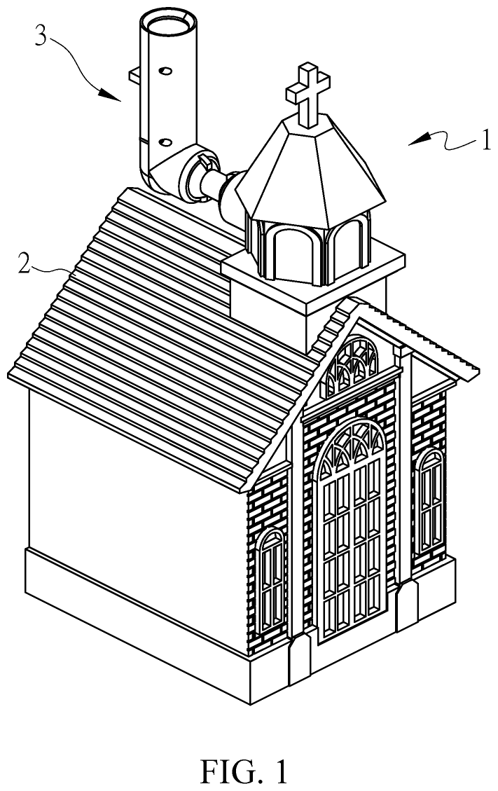

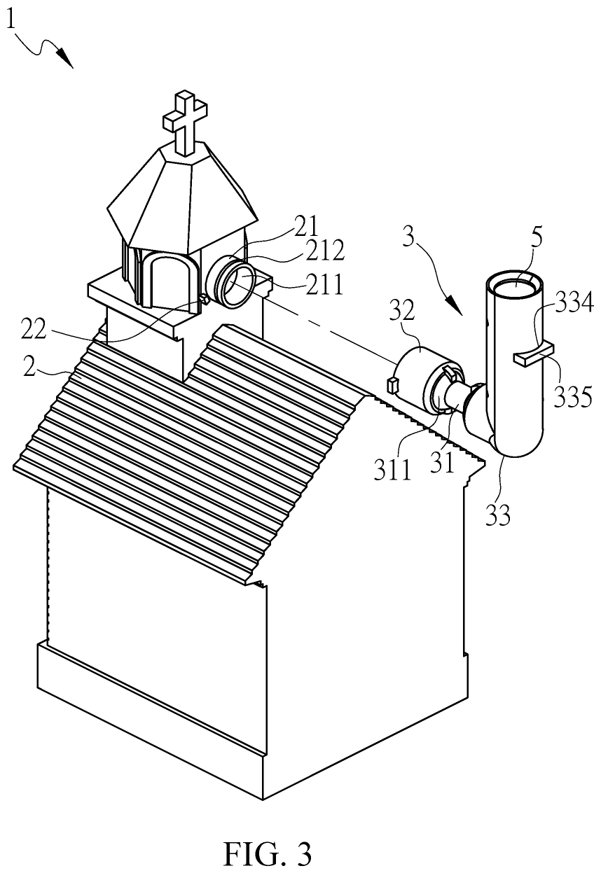

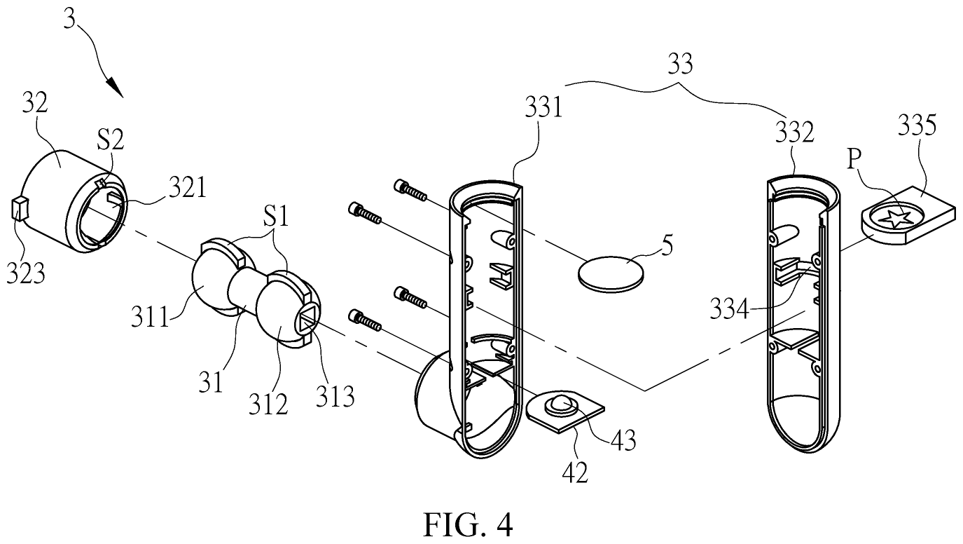

Referring to FIGS. 1-5, the present invention provides, in a preferred embodiment thereof, a light-and-shadow decoration (1), which generally comprises: a main decorative object (2), an omnidirectional rotation mechanism (3), and an electrical control unit (4).

The main decorative object (2) comprises a three-dimensional structure having a hollow interior. The present invention imposes no specific constraint to the structure or configuration of the main decorative object (2); however, a church configuration is taken as an example in the drawings. The main decorative object (2) is provided, at one side thereof, with a retaining seat (21), and in the instant embodiment, the retaining seat (21) is of a cylindrical configuration that includes a through hole (211) extending in an axial direction thereof and in communication with the interior of the main decorative object (2). Also, a stop (22) is arranged on the main decorative object at a location adjacent to the retaining seat (21).

The omnidirectional rotation mechanism (3) comprises a support axle (31), a rotation base (32), and a projector (33). The support axle (31) has two ends that are respectively provided with a first universal joint ball (311) and a second universal joint ball (312). Each of the first universal joint ball (311) and the second universal joint ball (312) has a surface on which a first constraining part (S1) is provided, and in the instant embodiment, the first constraining part (S1) comprises ribs that are arranged symmetric to each other. The support axle (31) is formed therein a channel (313) extending in an axial direction thereof and in communication with the through hole (211) and an interior of the projector (32).

The rotation base (32) has one side that is formed with a first ball socket (321) mating the first universal joint ball (311) and an opposite side rotatably mounted to the retaining seat (21) of the main decorative object (2) in order to selectively rotate relative to the main decorative object (2). In the instant embodiment, the rotation base (32) is rotatably mounted to the retaining seat (21) in such a way that a groove (212) is circumferentially formed in an outer surface of the retaining seat (21) and a circumferential block (322) is formed as being raised inward from an inner circumference of the rotation base (32). With the rotation base (32) being so mounted to the retaining seat (21), the circumferential block (322) is received into and located in the groove (212) and is rotatable along the groove (212). However, this is not limitative and any means that allows the rotation base (32) to be mounted to the retaining seat (21) in a rotatable manner is considered belonging to the scope of the present invention.

The projector (33) is formed of two casing members (331, 332) that are combinable with each other. The projector (33) is provided, at one side thereof in an axial direction, with a lighting cover (5) and is also provided, at an opposite side thereof in a direction perpendicular to the axial direction, with a second ball socket (333) that corresponds to and mates the second universal joint ball (312). Each of the first ball socket (321) and the second ball socket (333) is provided with a second constraining part (S2) engaging with the first constraining part (S1) corresponding thereto, and in the instant embodiment, the second constraining part (S2) comprises grooves that are arranged symmetric with each other. With the arrangement of the first constraining part (S1) and the second constraining part (S2), rotation of the support axle (31) and the projector (33) is only allowed along the second constraining part (S2) that serves as a guide track, so as to impose constraint to an angle of rotation of the support axle (31) relative to the rotation base (32) and also to impose constraint to an angle of rotation of the projector (33) relative to the support axle (31).

The electrical control unit (4) comprises a power supply portion (41), a circuit board (42), at least one light-emitting element (43), and a switch (44). The power supply portion (41) is arranged in the interior space of the main decorative object (2) and may include a power source that is supplied from a battery or an electric main. The circuit board (42) and the switch (44) are in electrical connection with the power supply portion (41). The switch (44) is provided for selectively turning on or shutting down supply of electrical power from the power supply portion (41). The light-emitting element (43) is in electrical connection with the circuit board (42), so that the circuit board (42) is operable to control sequencing of change of light color of the light-emitting element (43). Light emitting from the light-emitting element (43) transmits through the lighting cover (5) to project to the outside.

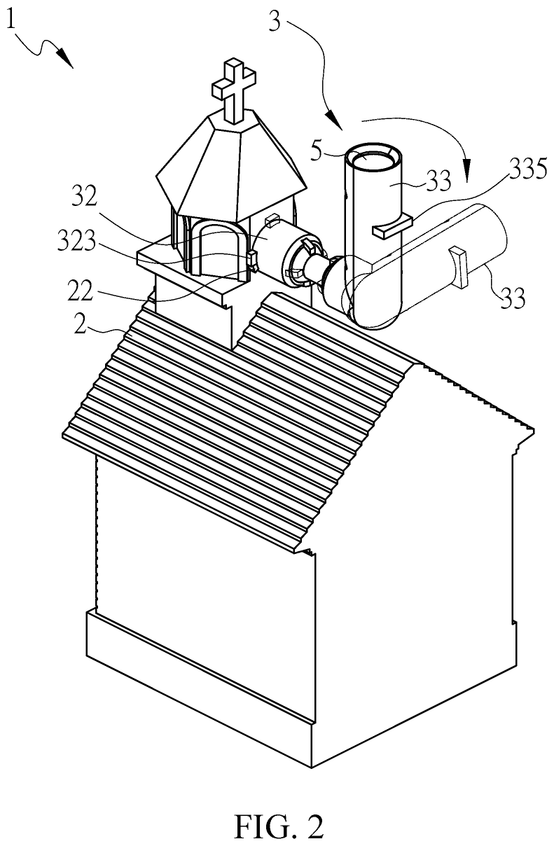

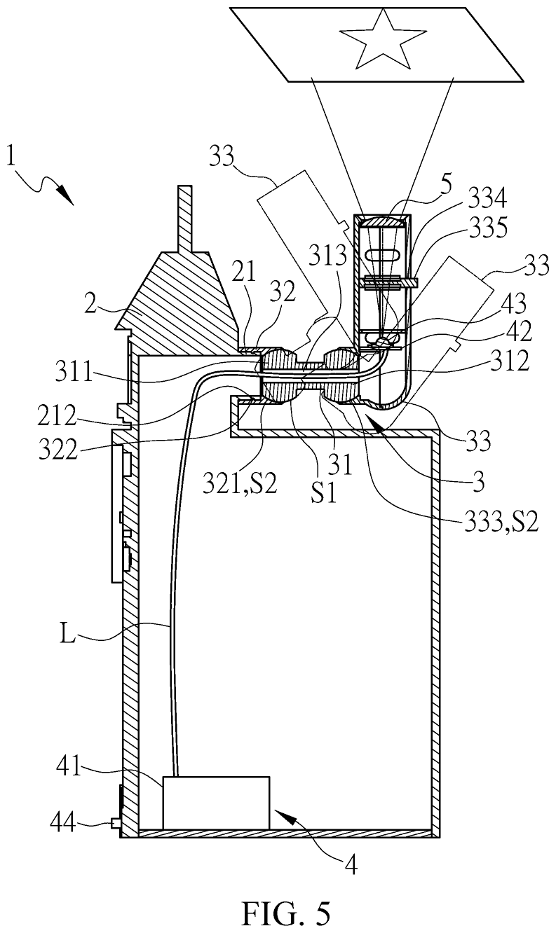

In the instant embodiment, the lighting cover (5) comprises a convex lens. The projector (33) is provided with an insertion slot (334) arranged between the light-emitting element (43) and the lighting cover (5) and comprises a light grating plate (335) that includes a pattern (P) and is removably inserted into and retained in the insertion slot (334). As such, the pattern (P) of the light grating plate (335) is transferred by the light from the light-emitting element (43) and enlarged by the lighting cover (5) to project on an object, such as a wall, a floor, a curtain, and a piece of furniture. Referring to FIGS. 2 and 5, the present invention makes use of the arrangement of the omnidirectional rotation mechanism (3) to allow a user to adjust, as desired, the projection angle of the light from the light source for casting a projection shadow of the pattern (P) on the outside object.

Following the above description, a wire (L) of the light-emitting element (43) extends through the channel (313) and the through hole (211) to connect to the power supply portion (41). To prevent the wire from breaking due to excessive rotation, the rotation base (32) is provided, on an outside surface thereof, with a protrusion portion (323), such that when the rotation base (32) is rotated to a predetermined angular position, the protrusion portion (323) is brought into contact with the stop (22) of the main decorative object (2), so that the user is prohibited from making further rotation.

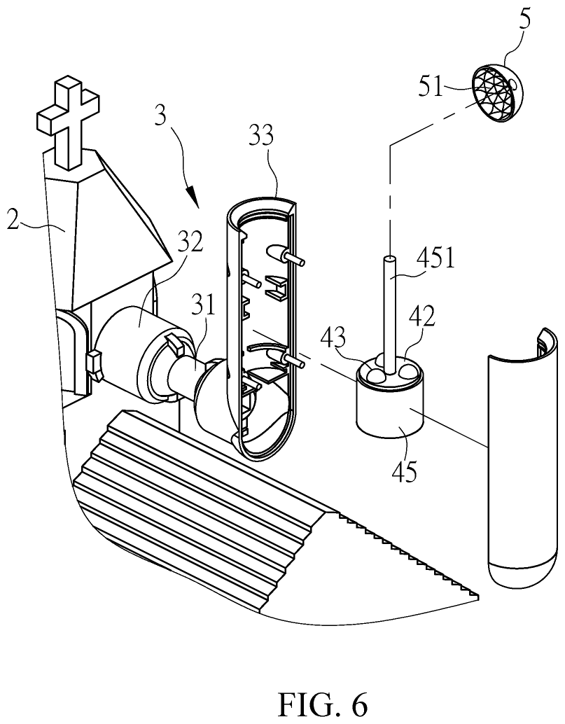

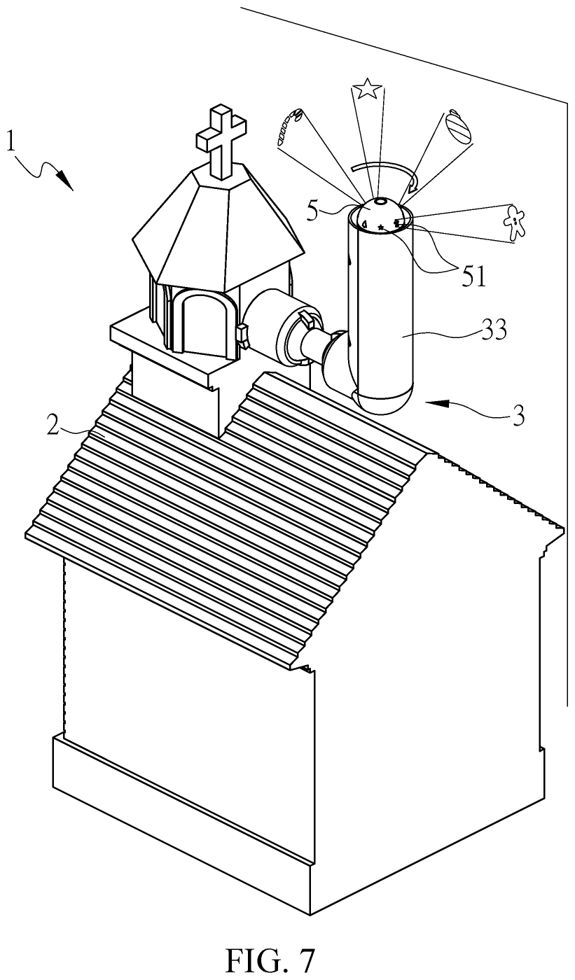

Referring to FIGS. 6 and 7, an illustrative example of the present invention that is provided as a modification of the embodiment describe above is shown, and description of similar parts will not be repeatedly provided therein. In the instant example, the electrical control unit (4) further comprises a motor (45), which is mounted in the interior space of the projector (33) and is in electrical connection with the power supply portion (41). The motor (45) includes a rotating spindle (451), and one end of the rotating spindle (451) is coupled to the lighting cover (5) to drive the lighting cover (5) to rotate.

In the instant example, the lighting cover (5) includes a texture structure (51) formed on a surface thereof. As shown in FIG. 5, the texture structure (51) comprises multiple facets or planar surfaces that are set at different angles and are interconnected with one another. The light from the light-emitting element (43), when irradiating the texture structure (51), is refracted by the facets at different angles toward the outside, such that through rotation caused by the motor (45), a dynamic light-and-shadow effect is generated.

Further, as shown in FIG. 7, the texture structure (51) may alternatively or additionally include laser engraved patterns, which are formed by providing a coating layer on an inside surface or an outside surface of the lighting cover (5), followed by removing a part of the coating layer through laser engraving to form a light-transmitting part, which, upon being irradiated with the light of the light-emitting element (43), projects the laser engraved image toward an object, and rotation driven by the motor (45) provides the invention with a dynamic light-and-shadow effect.

1. A light-and-shadow decoration, comprising:
a main decorative object, which comprises a three-dimensional structure having a hollow interior, the main decorative object comprising a retaining seat provided on one side thereof;
an omnidirectional rotation mechanism, which comprises a support axle, a rotation base, and a projector, the support axle having two ends respectively formed with a first universal joint ball and a second universal joint ball, the rotation base having one side in which a first ball socket mating the first universal joint ball is formed, the projector having one side in which a second ball socket mating the second universal joint ball is formed and an opposite side on which a lighting cover is provided, the omnidirectional rotation mechanism being rotatably mounted to the retaining seat of the main decorative object by means of the rotation base so as to be rotatable relative to the main decorative object, such that the support axle is movable relative to the retaining seat by means of a combination of first rotation of the rotation base relative to the retaining seat and a second rotation of first universal-joint ball relative to the rotation base, a rotation axis of the first rotation being different from a rotation axle of the second rotation; and
an electrical control unit, which comprises a power supply portion disposed in the interior of the main decorative object and at least one light-emitting element disposed in an interior of the projector and in electrical connection with the power supply portion, light from the light-emitting element transmitting through the lighting cover to project to the outside,
wherein each of the first universal joint ball and the second universal joint ball has a surface that is formed with a first constraining part, and each of the first ball socket and the second ball socket is formed with a second constraining part mating a respective one of the first constraining parts corresponding thereto so as to limit a rotation angle of the support axle relative to the rotation base and also to limit a rotation angle of the projector relative to the support axle.

2. The light-and-shadow decoration according to claim 1, wherein the lighting cover comprises a convex lens; and the projector is provided with an insertion slot arranged between the light-emitting element and the lighting cover and further comprises a light grating plate that comprises a pattern and is removably insertable into the insertion slot.

3. The light-and-shadow decoration according to claim 1, wherein the electrical control unit further comprises a motor, which is mounted in the interior of the projector and is in electrical connection with the power supply portion, the motor comprising a rotating spindle, the rotating spindle having one end connected to the lighting cover, so as to drive the lighting cover to rotate, the lighting cover having a surface that is formed with a texture structure.

4. The light-and-shadow decoration according to claim 3, wherein the texture structure comprises multiple planar surfaces that are set at different angles and are interconnected with each other or laser engraved images.

5. The light-and-shadow decoration according to claim 1, wherein the retaining seat is formed with a through hole extending in an axial direction thereof and in communication with the interior of the main decorative object, and the support axle is formed with a channel extending in an axial direction thereof and in communication with the through hole and the interior of the projector.

6. (canceled)

7. The light-and-shadow decoration according to claim 1, wherein the main decorative object is provided with a stop at a location adjacent to the retaining seat, and the rotation base is provided with a protrusion portion, such that when the rotation base is being rotated to a predetermined angular position, the protrusion portion is brought into contact engagement with the stop.

8. The light-and-shadow decoration according to claim 1, wherein the electrical control unit further comprises a switch, which selectively activates or deactivates supply of electrical power from the power supply portion, and a circuit board, which is operable to control sequencing of change of light colors of the light-emitting element.
